(19) United States
(12) Patent Application Publication
(10) Pub. No.: US 2006/0080138 A1
(43) Pub. Date: Apr. 13, 2006

(54) Method for providing health care products and services

(76) Inventor: Ron Clark, Valparalso, IN (US)

Correspondence Address: MARK S. MORRISON, 1508 SPRINGHILL ROAD, WARSAW, IN, 46580, US

(21) Appl. No.: 10/958,151

(22) Filed: Oct. 4, 2004

(51) Int. Cl. G06Q 10/00; G06Q 50/00

(52) U.S. Cl. 705/2

(57) ABSTRACT

A method for a retail establishment to provide health care products and services to health care consumers by employing a trained medical professional, such as a physician's assistant, nurse, nurse practitioner, physical therapist or a certified athletic trainer, as a customer assistant. The goods and services provided by the customer assistant may include interviewing each health care consumer about bodily ailments and disabilities, providing diagnostic services, assessments and evaluations to the health care consumer, discussing the management and rehabilitation of such ailments and disabilities with the health care consumer, providing personalized information to the health care consumer regarding possible modes of treatment, and offering goods and services for the treatment of such bodily ailments and disabilities to the health care consumer.

### CROSS-REFERENCE TO RELATED APPLICATIONS

Not applicable.

### STATEMENT REGARDING FEDERALLY SPONSORED RESEARCH

Not applicable.

### REFERENCE TO MICROFICHE APPENDIX

Not applicable.

### BACKGROUND OF THE INVENTION

The present invention relates to a system and method of providing to health care consumers a program of health care and lifestyle education and related health care products and diagnostic and treatment services. More specifically, the present invention relates to a method of providing personalized health and lifestyle education, health care products and diagnostic and treatment services to a health care consumer by a trained health care professional at a retail establishment.

Over the next fifteen years, the number of people in America over the age of 65 will more than double. Historically, people in this age group demand vast amounts of medical care due to the normal effects of aging. Orthopedic services to this age group are six times greater than those given to persons between the ages of 20 to 40 years. It is expected that the historical increase for demand for services by the older members of the population will be exacerbated by the fact that it is the baby boomer generation that will be reaching the age of retirement during this period. The baby boomer generation has been and is expected to remain much more physically active than previous generations. As the level of physical activity increases, the risk for injury generally rises as well. It is expected that the baby boomer generation will put increasing demands on the traditional health care system disproportionate to their numbers because of the increased level of physical activity and the concomitant increase in aches and pains and injuries resulting from the increase in physical activity and due to the aging process.

This increased demand for medical services will increase the strain on the already overburdened traditional health care system. In the traditional health care system, to prevent overburdening medical specialists with unnecessary referrals, when a health care consumer seeks treatment, the consumer first must visit a primary care physician at a clinic or hospital for initial diagnosis and treatment before being referred to a specialist with specialized training in the diagnosis and treatment of the consumer's specific condition or injury. For example, when a health care consumer suffers from injuries due to minor trauma or aches and pains from overactivity or a sports related injury, the consumer first must visit a primary care physician for initial diagnosis and treatment before being referred to an orthopedic surgeon who has specialized training in the diagnosis and treatment of such trauma and injuries. Often, even after the referral to a medical specialist, the consumer may suffer additional delay in treatment due to diagnostic services which may be required by the medical specialist to make a diagnosis.

Consequently, a health care consumer complaining of injuries due to minor trauma or aches and pains from overactivity must suffer the delay, inconvenience, and expense of multiple appointments with multiple tiers of health care providers over a period of days or weeks before gaining access to a health care professional who has the requisite training and experience and information to identify appropriate treatment regimes and suggest possible modalities of treatment and who has specific experience in identifying, evaluating, and treating such injuries and complaints.

Health care consumers have become increasingly dissatisfied with the delay, inconvenience, and expense of seeking treatment from the traditional health care system and have been turning more and more to non-traditional health care providers for treatment and cure. Unfortunately, outside the traditional health care system, there are few providers where consumers may obtain accurate health care information directly from trained health professionals. Pharmacists at drugstores do offer advice regarding non-prescription drugs and products. Many department stores offer an assortment of braces, pads, and hot or cold therapy devices but provide little service or advice regarding the use of such products. Health food and nutritional supplement stores are popular, but represent a highly commercialized and often unscientific approach to treating health problems. These stores have been known to offer unregulated products which are later withdrawn from the market after facing governmental scrutiny. Many consumers have turned to naturopathic and alternative medicine providers whose training and practice are held in suspicion by traditional health care providers. Others have sought information from the internet which abounds in websites containing information and advice of dubious quality presented by anonymous individuals. Outside of traditional health care providers, consumers have few sources from which they can obtain reliable, personalized health care information and advice from trained health professionals. Consumers have had virtually no choice outside the traditional health care system in obtaining diagnostic services or advice based upon the results of diagnostic services.

Health care consumers have need of direct access to professional health care information and guidance in selecting appropriate services and products which will allow them to accurately self diagnose complaints, to choose appropriate rehabilitation techniques and products for treatment, to be educated regarding behaviors which reduce the chance of further injuries, and permit them to determine whether or not they should seek treatment from a traditional health care provider.

Accordingly, a need exists for a method and system of providing health care consumers with professional health care information, products, and services outside the traditional health care system.

### BRIEF SUMMARY OF THE INVENTION

In accordance with an aspect of the present invention, personalized health care and lifestyle information relating to common physical body ailments and disabilities is provided directly to a health care consumer at a retail establishment by a trained medical professional who is employed as a customer assistant by the retail establishment. Trained medical professionals are physician's assistants, nurses, nurse practitioners, physical therapists, and certified athletic trainers.

In accordance with an aspect of the present invention, personalized health care and lifestyle information relating to common physical body ailments and disabilities and health care goods and services are provided directly to a health care consumer in a retail establishment by a trained medical professional who is employed as a customer assistant by the retail establishment.

In accordance with another aspect of the present invention, personalized health care and lifestyle information relating to common physical body ailments and disabilities is provided directly to a health care consumer in a retail establishment by a certified athletic trainer who is employed as a customer assistant by the retail establishment.

In accordance with another aspect of the present invention, personalized health care and lifestyle information relating to common physical body ailments and disabilities and health care goods and services are provided to a health care consumer in a retail establishment by a certified athletic trainer who is employed as a customer assistant by the retail establishment.

In accordance with another aspect of the invention, personalized health care and lifestyle information relating to common physical body ailments and disabilities sufficient to permit a health care consumer in a retail establishment to evaluate and self-diagnose common physical body ailments and disabilities and make informed choices among available treatment options and products is provided directly to the health care consumer by a trained medical professional who is employed as a customer assistant by the retail establishment.

In accordance with another aspect of the invention, personalized health care and lifestyle information relating to common physical body ailments and disabilities sufficient to permit a health care consumer to evaluate and self-diagnose common physical body ailments and disabilities and make informed choices among available treatment options and products is provided in a retail establishment to the health care consumer by a certified athletic trainer who employed as a customer assistant by the retail establishment.

In accordance with another aspect of the invention, medical diagnostic services will be provided to a health care consumer in a retail establishment by a trained medical professional who is employed as customer assistant by the retail establishment.

In accordance with another aspect of the invention, medical diagnostic services will be provided to a health care consumer in a retail establishment by a certified athletic trainer trained in the use of the diagnostic equipment.

In accordance with another aspect of the invention, medical diagnostic services will be provided to a health care consumer in a retail establishment by a certified athletic trainer employed as a customer assistant by the retail establishment.

In accordance with another aspect of the invention, low power fluoroscopy diagnostic services will be provided to a health care consumer in a retail establishment by a trained health care professional trained in the use of the low power fluoroscope.

In accordance with another aspect of the invention, low power fluoroscopy diagnostic services will be provided to a health care consumer in a retail establishment by a trained health care professional employed as customer assistant by the retail establishment.

In accordance with another aspect of the invention, low power fluoroscopy diagnostic services will be provided to a health care consumer in a retail establishment by a certified athletic trainer trained in the use of the low power fluoroscope.

In accordance with another aspect of the invention, low power fluoroscopy diagnostic services will be provided to a health care consumer in a retail establishment by a certified athletic trainer.

In another aspect, a retail establishment will provide medical diagnostic services to health care consumers by certified athletic trainers trained in the use of the diagnostic equipment.

In another aspect, a retail establishment will provide low power fluoroscopy diagnostic services to health care consumers by certified athletic trainers trained in the use of the diagnostic equipment.

In another aspect, a retail establishment will provide medical diagnostic services to health care consumers and health care and lifestyle education sufficient to allow the health care consumers to evaluate and assess the results of the medical diagnostic services.

In accordance with another aspect of the invention, a retail establishment will provide medical diagnostic services to a health care consumer, and a trained medical professional who is employed by the retail establishment as a customer assistant will provide health care and lifestyle education sufficient to allow the health care consumer to evaluate and assess the results of the medical diagnostic services.

### BRIEF DESCRIPTION OF THE DRAWINGS

Not applicable.

### DETAILED DESCRIPTION OF THE INVENTION

The present invention is directed to a method for a retail establishment to provide health care products and services to health care consumers by employing one or more trained health care professionals, such as physician assistants, nurses, licensed nurse practitioners, physical therapists or certified athletic trainers, as customer assistants. Such customer assistants will interview the health care consumers about bodily ailments and disabilities and discuss the prevention, evaluation, management and rehabilitation of such ailments and disabilities and provide personalized and accurate information to the health care consumers regarding possible modes of treatment. The customer assistants will provide the health care consumers with general and personalized information regarding possible modes of treatment sufficient to permit the health care consumer to evaluate and self-diagnose his condition and make informed choices among available treatment options and products.

During the interview, the customer assistants may offer and provide medical diagnostic services and assessment to individual health care consumers at the retail establishment. The medical diagnostic services may include, but are not necessarily limited to, low power fluoroscopy of joints, and testing of carpal tunnel syndrome, osteoporosis, extremity oxygenation, joint laxity, blood pressure, pulmonary capacity, body fat measurement, flexibility, aerobic capacity, and treadmill stress testing. Upon receiving the results of any such medical diagnostic services, a customer assistant will review the results and the possible modes of treatment with the health care consumer to enable the health care consumer to better evaluate and self-diagnose his condition and make informed choices among available treatment options and products.

To assure the maintenance of quality of service at the retail establishment and compliance with state and federal regulatory and licensing requirements, a supervising physician will establish policies and procedures to be followed by customer assistants in providing services to health care consumers at the retail establishment. In addition, the supervising physician will review customer service reports, will provide continuing education to customer assistants, and will monitor services provided by customer assistants to health care consumers at the retail establishment as may be required by applicable laws and regulations. Where required by law or regulation, each customer assistant shall enter into a written agreement with a supervising physician setting forth the terms and conditions underwhich the supervising physician will supervise the performance of such customer assistants.

In the preferred embodiment, a certified athletic trainer who is trained to provide low power fluoroscopy diagnostic services is employed as a customer assistant in a retail establishment to provide health care products and services to health care consumers. Certified athletic trainers are medical professionals who specialize in the prevention, assessment, treatment and rehabilitation of injuries and illnesses that occur to athletes and the physically active. Certified athletic trainers are educated to serve as first responder medical personnel who are experts in orthopedic and musculoskeletal injury assessment and treatment. As such, a certified athletic trainer is ideal to be employed as a customer assistant in a retail establishment to provide health care products and services to health care consumers.

What is claimed is:

1. A method of providing health care goods and services comprising:
a) having a trained medical professional employed as a customer assistant by a retail establishment interview a health care consumer about bodily ailments and disabilities;
b) having the customer assistant discuss the management and rehabilitation of such ailments and disabilities with the health care consumer; and
c) having the customer assistant provide personalized information to the health care consumer regarding possible modes of treatment of such ailments and disabilities.

2. The method of claim 1, wherein the trained medical professional employed as a customer assistant by the retail establishment is a nurse.

3. The method of claim 1, wherein the trained medical professional employed as a customer assistant by the retail establishment is a certified athletic trainer.

4. The method of claim 1, wherein the trained medical professional maintains a valid license issued by a state or federal governmental agency which licenses trained medical professional.

5. The method of claim 3, wherein the certified athletic trainer maintains a valid license issued by a state or federal governmental agency which licenses certified athletic trainers.

6. The method of claim 1 further comprising:
having the customer assistant offer goods and services to the health care consumer for the management and rehabilitation of such ailments and disabilities.

7. The method of claim 6, wherein the trained medical professional employed as a customer assistant by the retail establishment is a nurse.

8. The method of claim 6, wherein the trained medical professional employed as a customer assistant by the retail establishment is a certified athletic trainer.

9. The method of claim 6, wherein the trained medical professional maintains a valid license issued by a state or federal governmental agency which licenses trained medical professionals.

10. The method of claim 8, wherein the certified athletic trainer maintains a valid license issued by a state or federal governmental agency which licenses certified athletic trainers.

11. A method of providing health care goods and services comprising:
a) having a trained medical professional employed as a customer assistant by a retail establishment interview a health care consumer about bodily ailments and disabilities;
b) having the customer assistant discuss the management and rehabilitation of such ailments and disabilities with the health care consumer;
c) having the customer assistant provide personalized information to the health care consumer regarding possible modes of treatment of such ailments and disabilities; and
d) having the customer assistant provide medical diagnostic services to the health care consumer.

12. The method of claim 11 wherein the customer assistant is a nurse.

13. The method of claim 11 wherein the customer assistant is a certified athletic trainer.

14. The method of claim 11, wherein the trained medical professional maintains a valid license issued by a state or federal governmental agency which licenses trained medical professionals.

15. The method of claim 13, wherein the certified athletic trainer maintains a valid license issued by a state or federal governmental agency which licenses certified athletic trainers.

16. A method of providing health care goods and services comprising:
a) having a trained medical professional employed as a customer assistant by a retail establishment interview a health care consumer about bodily ailments and disabilities;
b) having the customer assistant discuss the management and rehabilitation of such ailments and disabilities with the health care consumer;
c) having the customer assistant provide personalized information to the health care consumer regarding possible modes of treatment of such ailments and disabilities; and
d) having the customer assistant provide low power fluoroscopy diagnostic services to the health care consumer.

17. The method of claim 16 wherein the customer assistant is a nurse.

18. The method of claim 16 wherein the customer assistant is a certified athletic trainer.

19. The method of claim 16, wherein the trained medical professional maintains a valid license issued by a state or federal governmental agency which licenses trained medical professionals.

20. The method of claim 16, wherein the certified athletic trainer maintains a valid license issued by a state or federal governmental agency which licenses certified athletic trainers.

21. The method of claim 11 further comprising:
having the customer assistant provide to the health care consumer an assessment and evaluation based upon the diagnostic services.

22. The method of claim 21 wherein the customer assistant is a nurse.

23. The method of claim 21 wherein the customer assistant is a certified athletic trainer.

24. The method of claim 21, wherein the trained medical professional maintains a valid license issued by a state or federal governmental agency which licenses trained medical professionals.

25. The method of claim 23, wherein the certified athletic trainer maintains a valid license issued by a state or federal governmental agency which licenses certified athletic trainers.

26. The method of claim 16 further comprising:
having the customer assistant provide an assessment and evaluation to the health care consumer based upon the low power fluoroscopy diagnostic services.

27. The method of claim 26 wherein the customer assistant is a nurse.

28. The method of claim 26 wherein the customer assistant is a certified athletic trainer.

29. The method of claim 21, wherein the trained medical professional maintains a valid license issued by a state or federal governmental agency which licenses trained medical professionals.

30. The method of claim 28, wherein the certified athletic trainer maintains a valid license issued by a state or federal governmental agency which licenses certified athletic trainers.

31. The method of claim 21 further comprising:
having the customer assistant offer goods and services to the health care consumer for the management and rehabilitation of such ailments and disabilities.

32. The method of claim 31 wherein the customer assistant is a nurse.

33. The method of claim 31 wherein the customer assistant is a certified athletic trainer.

34. The method of claim 31, wherein the trained medical professional maintains a valid license issued by a state or federal governmental agency which licenses trained medical professionals.

35. The method of claim 33, wherein the certified athletic trainer maintains a valid license issued by a state or federal governmental agency which licenses certified athletic trainers.

36. The method of claim 26 further comprising:
having the customer assistant offer goods and services to the health care consumer for the management and rehabilitation of such ailments and disabilities.

37. The method of claim 36 wherein the customer assistant is a nurse.

38. The method of claim 36 wherein the customer assistant is a certified athletic trainer.

39. The method of claim 36, wherein the trained medical professional maintains a valid license issued by a state or federal governmental agency which licenses trained medical professionals.

40. The method of claim 38, wherein the certified athletic trainer maintains a valid license issued by a state or federal governmental agency which licenses certified athletic trainers.
